(19) United States
(12) Patent Application Publication
(10) Pub. No.: US 2019/0287553 A1
(43) Pub. Date: Sep. 19, 2019

(54) AUTOMATIC PHONOGRAPHIC RECORD PLAYING AND ARCHIVING DEVICE, SYSTEM AND METHOD

(71) Applicant: CHRISTOPHER GRIFFIN BYERLY, ANTIOCH, TN (US)

(72) Inventor: CHRISTOPHER GRIFFIN BYERLY, ANTIOCH, TN (US)

(21) Appl. No.: 16/357,091

(22) Filed: Mar. 18, 2019

Related U.S. Application Data
(60) Provisional application No. 62/644,522, filed on Mar. 18, 2018.

(51) Int. Cl. G11B 3/34; G11B 3/60

(52) U.S. Cl. CPC G11B 3/34; G11B 3/60

(57) ABSTRACT

A phonographic record playing device which accommodates automatic album track cueing, playback and/or album track audio recording/archiving functionality through the implementation of hardware, software and a plurality of control inputs and/or surfaces. The phonographic device uses sensors and motors in order to detect discrete album track locations and automatically position the device stylus on the album surface as desired. Software and hardware allow for the audio capture of desired album audio tracks including the appropriate association of album and audio track metadata for archiving, storage and retrieval.

### FIELD

The disclosure herein relates broadly to devices and methods for translating inscribed audio information from planar media, and more particularly, to phonograph record playing systems and methods of informed album identification, automatic track cueing and vinyl media digital archiving.

### BACKGROUND OF THE INVENTION

In recent years, innovations in hardware, network infrastructure and media compression have brought about major shifts in modes of media distribution. The ubiquity of mobile devices, wireless availability and compressed audio music formats have given rise to a growing affinity for digitally distributed music—a notable format having recently emerged in the form of digital music streaming. So it is curious that at the same time, there would re-emerge a sustained interest by consumers in one of the music industry's earliest modes of recorded music distribution—the vinyl record. While nostalgia is certainly a factor, it has been suggested that the increasing interest in vinyl records is the result of a more intimate relationship forged between artist and fan which is imbued by the tangible experience of vinyl and its richness of sound. Regardless of the impetus, a renewed consumer appreciation in vinyl music likely underlies recent initiatives by record companies to expand vinyl offerings citing robust margin and correlated repeat purchasing.

While it is apparent that music consumers are demonstrating a sustained appreciation for both the richness of vinyl sound and the convenience of audio streaming, they are however, unable to access record player constructs that more tightly integrate these formats through informed album identification, automated track cueing and simplified vinyl archiving for digital audio library integration.

While automated phonographic control systems have been implemented in prior devices, they have been constrained by cost, complexity and form factor. Traditional automatic control systems were often expensive to design and manufacture and have thus resulted in high end phonographic systems which make up a fraction of the phonograph retail market. Where more contemporary phonographic record playing devices have addressed automated control, they have often implemented atypical form factors using linear tracking systems opposed to stationary systems with pivoting tone arm assemblies.

Contemporary phonographic systems seeking to address a desire for vinyl archiving features have proven cumbersome and ineffective. While the introduction of USB-equipped phonographic record players provided a means of vinyl archiving, such configurations require users to engage in a complex series of operations in order to archive their vinyl music. Laborious tasks such as connecting cables, implementing audio editing software, cataloging titles and album art are time consuming and have had little impact toward inspiring the general consumer to archive their vinyl libraries. Furthermore, such systems typically offer very little, if any means to enable users to integrate their vinyl archive into their existing digital music library.

In short, many design strategies have been slow to leverage the breadth of wireless technology and mobile device capability as a means to enable vinyl music enthusiasts the ability to enjoy the convenience of informed album identification, automatic track cueing, simple vinyl archiving and mobile access to this vinyl archive.

With consideration for the aforementioned condition, the subsequent disclosure proposes a phonographic record player and methods intended to enable consumers a measure of flexibility and simplicity as it relates to experiencing vinyl in both traditional and mobile contexts. The general embodiment of the phonographic device is preferably presented as a stationary, two-stage plinth design, a rotating platter and a pivoting tone arm assembly. The device allows for analog vinyl record playing by typical means but in addition, allows for the simple instantiation of protocols for informed album identification, automatic track cueing, simple vinyl audio archiving and digital audio library integration—all of which may be achieved via a plurality of control surfaces on both the phonographic device or other computing or mobile computing device, or which may be achieved by voice activation through a voice command system.

### EMBODIMENTS

This disclosure expounds on embodiments intended to demonstrate manifestations of automatic phonographic record playing and archiving systems which are herein being proposed in order to improve upon prior art and other functional constraints existing within the scope of phonographic record player design and utility toward the continued improvement of such systems to those skilled in the art.

The embodiments presented herein represent both preferred and alternative embodiments of the device and may not necessarily depict the whole of embodiments and implementations of systems and methods of automatic phonographic record playing and archiving devices implied by this disclosure. Where such embodiments are not depicted, it should not be considered exclusionary.

The preferred embodiment of the device consists of a turntable device comprised of: a two-stage plinth system which is organized in a vertical configuration and separated by vibration dampening assemblies and materials; wherein the lower plinth houses a power supply, a drive motor, a motor-spindle coupling, a spindle, a platter, at least one microcomputer/controller with wireless and Bluetooth® functionality, an analog to digital audio converter and an integrated or external sound card. The lower plinth also houses an input/output bank, a phonographic preamplifier, at least one servo motor, a plurality of control surfaces, vertical supports and a microphone. The upper plinth supports, a cue lever comprised in part of a touch sensor; wherein the said sensor may disengage said servo motor(s). In addition, the upper plinth supports a dust cover, dust cover hinges/hinge receivers, and at least one pivoting tone arm assembly comprised of a base, a gimbal, a counterweight, an anti-skate mechanism, a tone arm shaft, and a head shell containing a stem comprised in part of a touch sensor; wherein said sensor may disengage said servo motor(s). In addition, the head shell supports a stylus/cartridge and at least one sensing assembly; wherein such sensor(s) may scan and identify discrete album track characteristics in part as a means of informed album identification, automatic track cue control and vinyl record archiving.

Vinyl album surface canning may inform album identification by at least the following discrete or combined means: 1—Scanned vinyl album surfaces and their resultant characteristics may be comparatively analyzed and correlated with a database of other scanned vinyl album surfaces containing associated metadata and/or 2—Scanned vinyl albums may be identified by other means of optical character recognition as occurs on the album surface.

In this disclosure, the nomenclature provided for the control surfaces are intended for the purpose of referencing the functionality of the automatic track cueing and archiving features of the phonographic device as described and may not necessarily represent a literal description of the control surface naming system.

Scanning may provide for automatic track cue control which may be activated by voice-control through the utilization of the phonographic device's onboard microphone or by other voice command systems such as Amazon Alexa®, Google Assistant® or Apple Siri®, or by a plurality of onboard control surfaces, mobile application or other computing device which allow for at least the automatic track cueing functionalities of ‘loop’, ‘shuffle’, ‘back’, ‘next’, ‘play’, ‘pause’ and ‘archive’; wherein the said means of activation of the ‘loop’ functionality causes the phonographic device to play all album tracks in sequence for a default or user-controlled duration; wherein the said means of activation of the ‘shuffle’ functionality causes the phonographic device to play the album tracks in a random order for a default or user-controlled duration; wherein the said means of activation of the ‘back’ functionality causes the phonographic device to play the previous album track; wherein the said means of activation of the ‘next’ functionality causes the phonographic device to play the subsequent album track; wherein the said means of activation of the ‘play’/‘pause’ functionality causes the phonographic device to play or pause an album track; wherein the said means of activation of the ‘archive’ functionality initializes the phonographic device to record all or selected vinyl album tracks, and to convert, format and associate the appropriate metadata (i.e., album, artist and track information, etc. . . . ) to such tracks.

In order to preserve accurate metadata correlation during the archiving process, users must confirm the album title of which they intend to archive tracks. The album title may be discovered in many ways which comprise the aforementioned means of informed album identification (Section 0011), the user may implement a mobile device application search of existing album database(s), i.e. Gracenote®, the user may implement a music audio recognition application, i.e. Shazam®, the user may implement a bar code scanning application or other optical character recognition application on a mobile device, or the user may implement voice activated album identification through the utilization of the phonographic device's onboard microphone or by other voice command systems such as Amazon Alexa®, Google Assistant® or Apple Siri®.

The digitally archived vinyl music may be stored locally on the phonographic device or stored remotely on external storage, the cloud or on a mobile or other computing device. The digitally archived vinyl music may preferably be configured and retrieved for playback from a mobile device or other computing device.

An onboard control surface, voice activation, mobile or other computing device may also control the ‘power’ state functionality; wherein such activation causes the phonographic device to switch the power on, off or into standby mode.

An onboard control surface, voice activation, mobile or other computing device may also allow for the selection of discrete drive motor speeds depending on the vinyl media type, i.e., 33⅓ RPM, 45 RPM or 78 RPM.

Audio output of the phonographic device may be referenced from speakers via conventional wired output or through wireless output such as Bluetooth®.

### BRIEF DESCRIPTION OF THE DRAWINGS

The drawings and descriptions in this disclosure are intended to be illustrative in nature and represent both preferred and alternative embodiments of the device. The embodiments presented herein may not necessarily depict the whole of all embodiments and the related implementations of such devices implied by this disclosure. Where such embodiments are not depicted, it should not be considered exclusionary.

Of a particular embodiment, some components may be intentionally omitted from certain drawings and indicated in others for the sake of providing visual clarity.

FIG. 1 Illustrates a front perspective view of one embodiment of the phonographic device.

FIG. 2 Illustrates a top view of one embodiment of the phonographic device.

FIG. 3 Illustrates the side view of one embodiment of the phonographic device.

FIG. 4 Illustrates the back view of one embodiment of the phonographic device.

FIG. 5 Illustrates the bottom view of one embodiment of the phonographic device.

FIG. 6 Illustrates the front/top exploded perspective view of one embodiment of the phonographic device.

FIG. 7 Illustrates the back/bottom exploded perspective view of one embodiment of the phonographic device.

FIG. 8 Illustrates a top view of an alternative embodiment of the device as described in Section [0040].

FIG. 9 illustrates a top view alternative embodiment/configuration of the device as described in Section [0047].

### DETAILED DESCRIPTION OF THE DRAWINGS

The following detailed description of the drawings presents a preferred embodiment of the device and should not be considered to be restrictive of other embodiments which may alternatively be comprised.

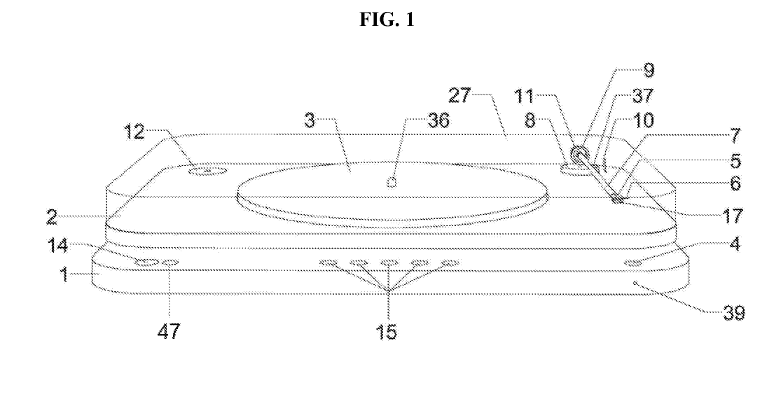

FIG. 1 represents the device as viewed from the front in a perspective view. This embodiment is comprised of a lower base plinth 1 and an upper plinth 2 which are organized vertically in a ‘two-stage’ orientation as a means to decouple vibrations associated user interaction of the control surfaces 4, 14, 15 or 47 (housed in the lower base plinth 1) from the tone arm assembly (supported in the upper plinth 2) and comprised of the head shell 5, a sensing source 17, the head shell stem 6, the tone arm shaft 7, the tone arm base 8, a gimbal 9, a counter weight 11, an anti-skate mechanism 37 and the tone arm cue lever 10. The further rationale of the ‘two-stage’ plinth system also serves to decouple the tone arm assembly from vibrations associated with device components, i.e., drive motor operation. In addition, the lower base plinth 1 also supports a spindle shaft 36 supporting a platter 3 capable of receiving vinyl records of various diameter. 45 RPM vinyl records may be accommodated atop the platter 3 using the adaptor 12 and drive motor speed selector 47. As noted, the lower plinth 1 houses a plurality of control surfaces 4, 14, 15 and 47 all of which are connected to a microcomputer/controller. Control surface 14 may represent a power button that is also connected to the power source and which when pressed and held will turn the device power on or off and when tapped, will put the device power state into low-power stand by mode. Control surfaces 15 may represent a bank of control surfaces that initiate the automated track cueing functionality of ‘loop’, ‘shuffle’, ‘back’, ‘next’ and ‘play/pause’ as described in Section [0013]. Control surface 4 may initiate the ‘archive’ functionality as described in Section [0013]. All control surface functionality may be initiated by a mobile or other computing device or by voice activation through the utilization of the phonographic device's onboard microphone 39 or by other voice command systems such as Amazon Alexa®, Google Assistant® or Apple Siri®.

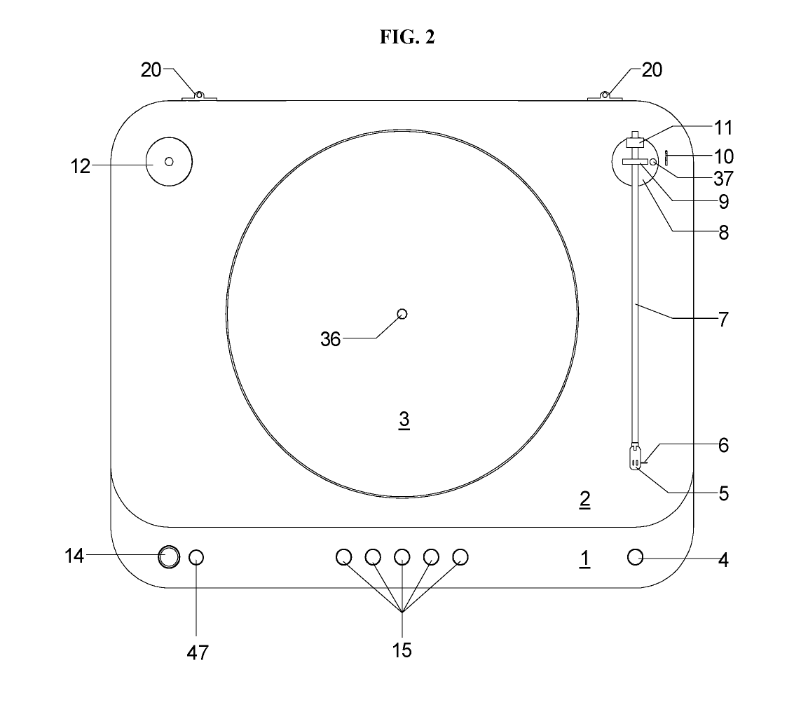

FIG. 2 represents the device as viewed from the top and in addition to the components described in FIG. 1, also depicts the hinge receivers 20 which are affixed to the upper plinth 2.

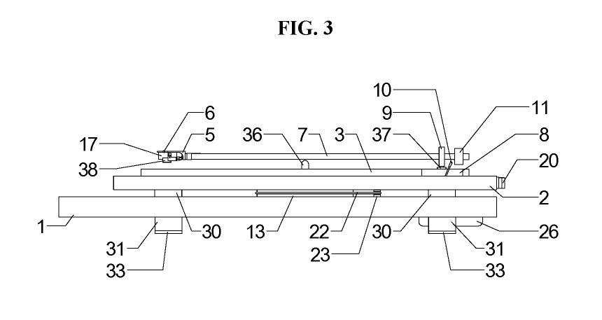

FIG. 3 represents the device as viewed from the side and identifies the stylus cartridge 38 and the sensor 17 and their respective relationship to the head shell 5. This drawing more clearly illustrates the ‘two-stage’ relationship of the lower base plinth 1 and the upper plinth 2 which are physically decoupled in part by the plinth spacers 30 and supported overall by the lower plinth supports 31 which rest atop the lower base plinth support feet 33. In addition, the spindle assembly is noted as being comprised of the spindle shaft 36 and the spindle pulley 13 which are connected to the drive motor shaft 23 by the drive motor belt 22. The relationship of these components is made more apparent in subsequent descriptions and drawings. Finally, this illustration indicates the power source and phonographic preamplifier 26 location which is depicted to extend below the lower plinth 1 where space and ventilation might require.

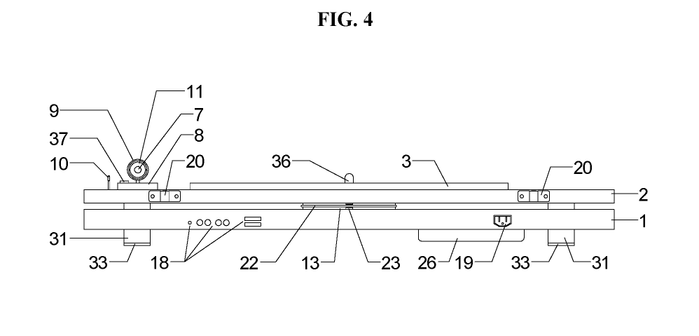

FIG. 4 represents the device as view from the back and serves to illustrate the relative locations of the aforementioned components and where applicable, their relationship to the audio and data input/output bank 18, which may be comprised of a ‘headphone’ out, a left and right ‘phono in’ and ‘phono out’ and may provide as well for USB or other data transfer capability. The power cable input 19 is housed within the lower base plinth 1.

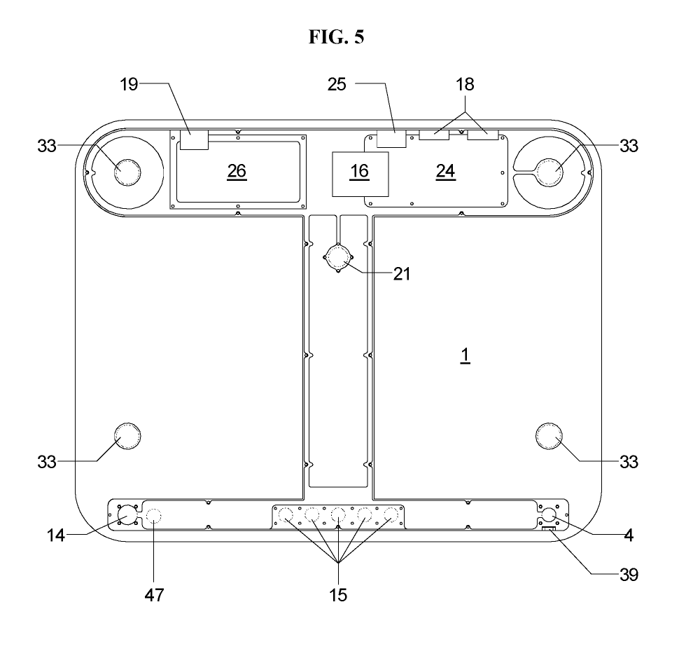

FIG. 5 represents the device as seen from the bottom of the lower base plinth 1. In this illustration, the control surfaces 4, 14, 15 and 47 and their respective housings within the lower plinth 1 are identified. The drive motor 21 and its housing are identified as are the microphone 39 and its location within the lower base plinth 1. The lower base plinth support feet 33 are indicated at four locations and as previously noted, the input/output banks 18, the power input 19 and the power source/phonographic preamplifier 26 are indicated. The micro computer/controller 24 with wireless and Bluetooth® functionality is illustrated and its context to a region dedicated for sensor processing 16 and onboard memory 25.

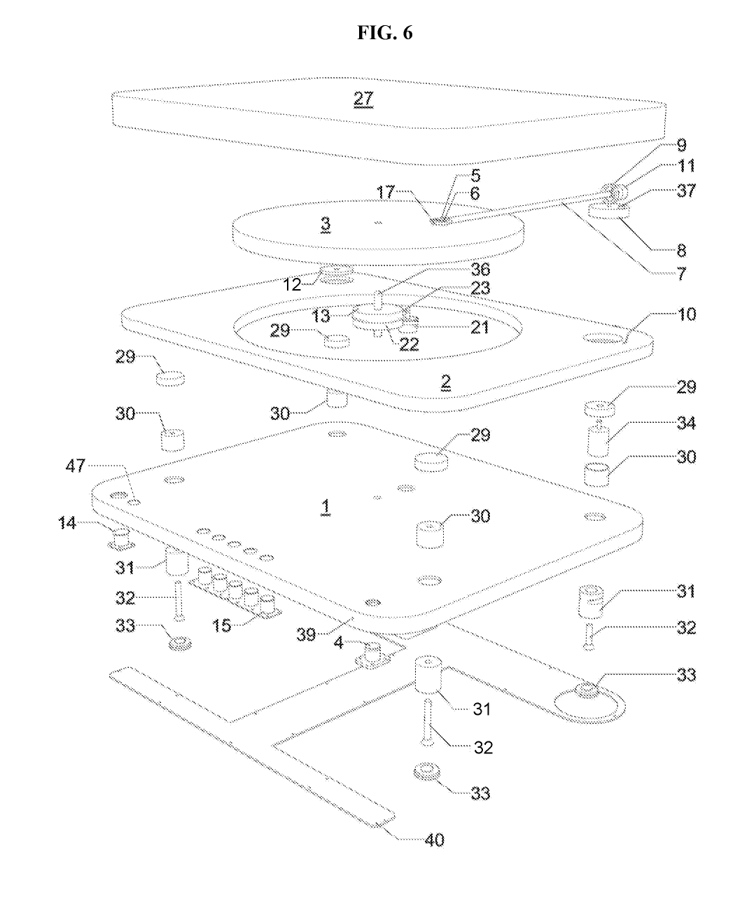

FIG. 6 represents an exploded view of the device as viewed in perspective from the front. This illustration indicates the dust cover 27 and the lower base plinth shroud 40. The illustration provides increased clarity regarding one embodiment of the drive assembly wherein the spindle shaft 36 is seated within the lower base plinth 1 and receives the spindle pulley 13 which supports the platter 3. This assembly is connected to the drive motor shaft 23 by the drive motor belt 22 all of which are driven by the drive motor 21 which is housed within the lower base plinth 1.

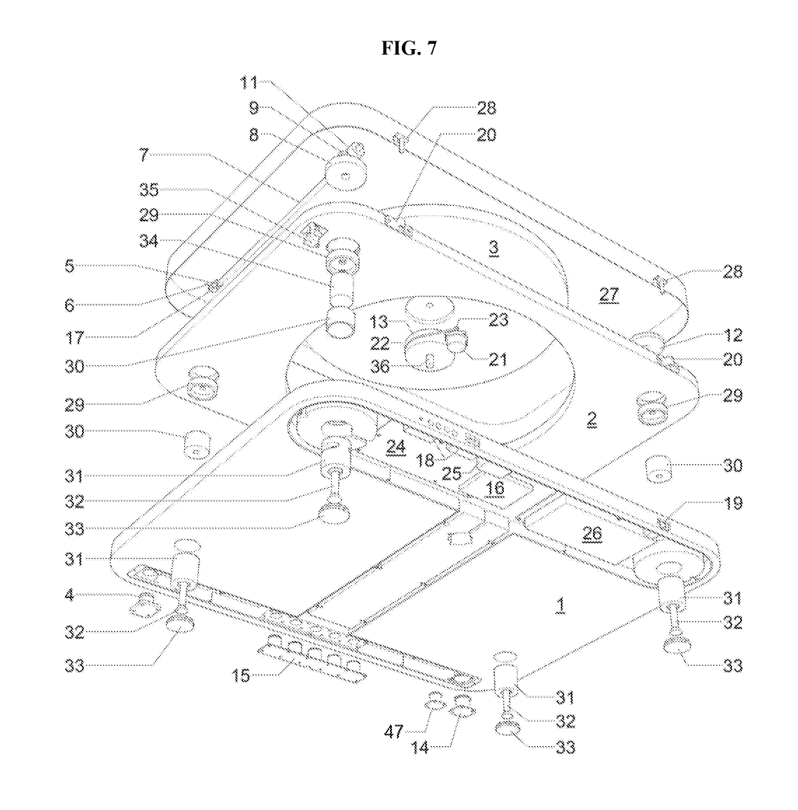

FIG. 7 represents an exploded view of the device as viewed in perspective from the back. This illustration provides a spatial relationship of many components noted in the previously described back and bottom views and in addition notes the location of the cue lever servo motor 35 and its housing within the upper plinth 2. This illustration provides more detail regarding one embodiment of the ‘two-stage’ plinth decoupling assembly which are comprised of the lower plinth support foot 33, a lower plinth support screw 32, the lower plinth support 31, the plinth spacer 30 and the vibration dampening cap 29 which is made of natural and/or man-made composite demonstrated to minimize low frequency vibrations and micro vibrations. A unique embodiment of this assembly occurs beneath tone arm assembly where the tone arm servo motor 34 resides which controls the movement of the tone arm in the X-Y (‘left’ and ‘right’) axis when invoked by the microcomputer upon activation of the various control surfaces 4, 14, 15 or 47. The cue lever servo motor 35 controls the cue lever position in the Z (up′ and ‘down’) axis. For example, a user may select the control surface 15 for the ‘shuffle’ functionality. The device may then ‘scan’ the record surface in the X-Y axis using the tone arm servo motor 34 and sensor 17 to determine the individual track locations and in this case, subsequently play these tracks in a random order using the sensor 17 data to locate the tone arm stylus 38 in the X-Y axis and then lowering the tone arm stylus 38 to the record surface using the cue lever servo motor 35. As noted, track selection can be done manually as neither servo motor is engaged by default and only engaged when activated by an automated functions via voice, mobile device, or other computing device or the control surfaces 4, 14, 15 or 47. In the event that automated functions are manually interrupted, the head shell stem 6 and the cue lever 10 are comprised in part of a touch sensor either of which when activated, will disengage both the cue lever servo motor 35 and the tone arm servo motor 34. Also indicated are the dust cover hinges 28 and their relative relationship to the dust cover 27 and the dust cover hinge receivers 20.

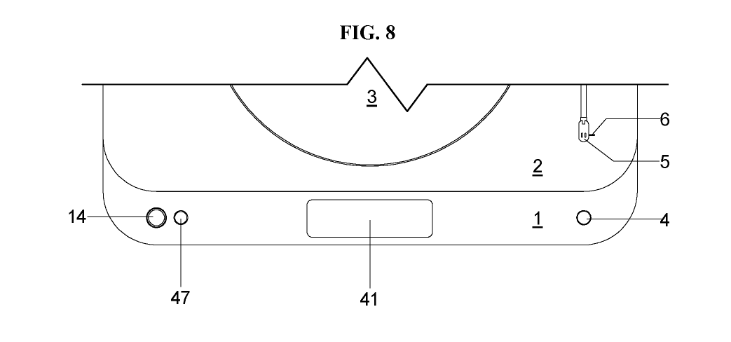

FIG. 8 illustrates a top view of an alternative embodiment of the device as described in Section 0040.

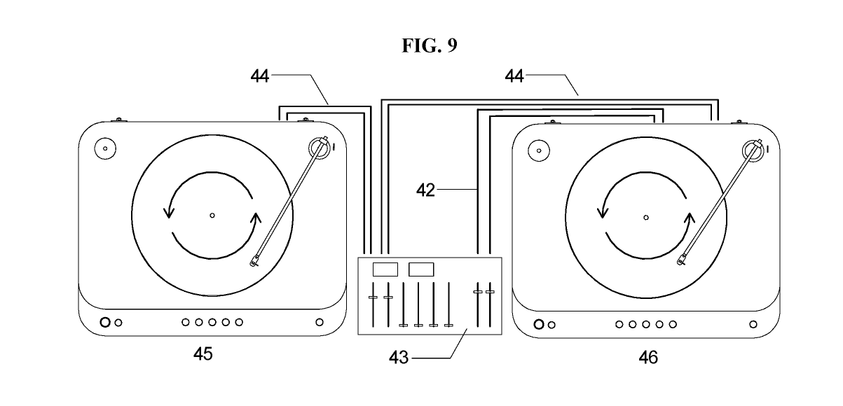

FIG. 9 illustrates a top view of an alternative embodiment/configuration of the device as described in Section 0047.

### ALTERNATIVE EMBODIMENTS AND SUPPLEMENTAL DRAWING DESCRIPTIONS

An alternative embodiment may implement a touch screen display control surface 41 (FIG. 8) in lieu of a bank of control surfaces 15 as a means to enable users the ability to customize control surface functionality. For example, a user may prefer to add a “repeat” control surface functionality which may play a particular track repeatedly. In addition, the touch screen may be used in lieu of a mobile device touch screen allowing users the ability to search for and confirm album information when archiving.

Other embodiments of the device may omit the upper plinth 2 and the vibration dampening cap 29 and plinth spacer 30 wherein the aforementioned components housed in and/or further comprising the upper plinth 2 in the preferred embodiment could alternatively be housed in and/or further comprise the lower base plinth 1 in a single stage design.

Other embodiments of the device may implement a direct drive motor system to drive the platter 3 in lieu of the belt driven system as described in the preferred embodiment. Such drive systems allow for the reversing of the platter's direction (‘scratching’) with less strain on the drive system.

### Archiving Functionality

In general, the archiving functionality requires the processes of capturing and converting the audio signal, correlating the appropriate track metadata with the audio files, formatting the audio files and the storage and configuration of the audio files with associated metadata for mobile library integration and playback.

In the preferred embodiment, the phonographic device allows for simple archiving of vinyl music. This may be accomplished by initiating the control surface functionality of the archive button 4 or touch screen 41 on the device or by activating this control surface functionality using a mobile device and application. In addition, this functionality may be initiated by providing voice commands to the device microphone 39 or to voice command systems such as Amazon Alexa®, Google Assistant® or Apple Siri®.

### Archiving—Sample Use Cases

A sample use case demonstrates one way in which the archiving process may proceed. With the vinyl album resting on the platter 3, the user implements a mobile or other computing device application or control surface 41 to search for and confirm the corresponding album title. Using a mobile or other computing device or control surface 41, the user may then confirm the album side (i.e., Side A/Side B) and select from a list, the tracks to be archived. The user may press an ‘archive’ button on a mobile device app or control surface 4 wherein in part, the sensor 17 ‘scans’ the vinyl record surface/track characteristics and archiving of the selected tracks commences wherein the digitally archived files are automatically correlated with album metadata, configured and stored locally and/or remotely allowing for playback from a mobile or other computing device.

In another sample use case, a user sets a vinyl record on the platter 3, presses a ‘power’ button 14 and then presses an ‘archive’ button 4. Using in part, the sensor 17, the device ‘scans’ the record surface to identify and store album surface characteristics. At this stage, the stored album surface characteristics may be implemented by the device as a means to suggest the corresponding album title (informed album identification) which may be presented to the user via touch screen 41 or via mobile or other computing device application. Through these means, the user may confirm this suggestion, conduct a different album title search via mobile application or the touch screen 41, or bypass album title confirmation. This pending confirmation may be indicated by a flashing ‘archive’ indicator 4 on the device. If desired, this indicator may be overridden by depressing the flashing indicator wherein archiving of the entire side of the vinyl album commences. The digital files are stored locally and/or remotely and the appropriate album metadata may be confirmed and automatically correlated for complete archiving at a latter time.

A final sample use case demonstrates an example by which multiple devices may be configured to allow for the archiving of output from multiple phonographic devices (FIG. 9). In this condition, an alternate embodiment of the device as noted in [Section 0042] (implementing a direct drive motor) may be preferred. In this case, a DJ may connect two or more phonographic devices 45 and 46 either wirelessly or via the audio input/output bank 18 sending an output signal 44 to a mixing console 43. In this configuration, one of the phonographic devices may be designated as a ‘master’ device 46 wherein the instantiation of the ‘archive’ function on the ‘master’ device overrides its default audio archiving input source which is normally routed from the device's stylus output signal. Instead the archiving input source is routed from audio signal 42 to the device's audio input bank. Here, the signal to be recorded and archived comprises all device sources from the mixing console. Such device configuration would enable a DJ the opportunity to create a live ‘performance’ of mixing and scratching across multiple devices and wherein the digitally archived file is configured and stored locally and/or remotely for playback.

The foregoing description of the preferred and alternative embodiments are presented herein for illustrative and descriptive purposes and should not be considered restrictive. Such embodiments are capable of modifications and may be practiced otherwise than specifically described. When practiced as such, the reference or non-reference to a particular embodiment shall not be interpreted to limit the scope of protection. It is intended that the scope of protection be applied based on the appended claim.

What is claimed is:

1. A phonographic record playing device comprising:
a base plinth comprising:
a platter;
a spindle;
a drive motor;
a drive motor coupling or belt;
a plurality of control surfaces;
a power supply and power cable;
a microcomputer/controller w/integrated or external sound card;
on board memory/storage;
an analog to digital audio converter;
an audio input/output bank;
a data input/output bank;
vertical support/sound dampening assemblies;
at least one tone arm servo motor;
a microphone;
a phonographic pre-amplifier;
a shroud;
a sensor processing unit;
an upper plinth comprising:
a 45 RPM adapter;
a dust cover, hinges and hinge receivers;
at least one cue lever servo motor;
a cue lever comprising:
a touch sensor;
a pivoting tone arm assembly comprising:
a tone arm base;
a tone arm shaft;
a counter weight;
a gimbal;
an anti-skate mechanism;
a head shell comprising:
a cartridge and stylus;
at least one sensor;
a head shell stem comprising:
a touch sensor.
wherein the base plinth supports said spindle which supports said platter which receives phonographic records; wherein said platter is driven by said drive motor and motor spindle coupling or belt; wherein said tone arm servo motor may pivot said pivoting tone arm assembly; wherein said cue lever servo motor may lower said tone arm assembly as to bring said stylus into contact with said phonographic record surface or said cue lever servo motor may raise said tone arm assembly as to remove said stylus from contact with said phonographic record surface.

2. The phonographic record playing device of claim 1, wherein said microcomputer/controller comprises a software application capable of controlling automatic track cueing of the phonographic device wherein automatic track cueing comprises the following operating functions:
play all tracks on a side of a phonographic record in sequence;
play all tracks on a side of a phonographic record in a random order;
play the previous track;
play the subsequent track;
play a track;
pause a track.

3. The phonographic record playing device of claim 1, wherein said microcomputer/controller, said integrated or external sound card, said analog to digital audio converter and said on-board memory may further comprise software applications capable of the controlling the archive operating function of the device which comprises:
capturing and converting the selected track(s) from an analog to a digital signal;
formatting the track(s) to a desired digital format;
correlating the track(s) with metadata;
saving the track(s) locally and/or remotely.

4. The phonographic record playing device of claim 1, wherein said microcomputer/controller further comprises a software application capable of controlling the power state of the phonographic device wherein the power state control comprises the following operating functions:
turning the power on;
turning the power off;
putting the power state in a low power consumption mode.

5. The phonographic record playing device of claim 1, wherein said microcomputer/controller further comprises a software application capable of regulating the drive motor speed as to accommodate said phonographic record.

6. The phonographic record playing device of claim 1, wherein said plurality of control surfaces comprises one or more buttons capable of controlling the operating functions of claim 2, claim 3, claim 4 or claim 5.

7. The phonographic record playing device of claim 1, wherein said plurality of control surfaces comprises one or more touch screen displays capable of controlling the operating functions of claim 2, claim 3, claim 4 or claim 5.

8. The phonographic record playing device of claim 1, wherein the initiation of the operating functions of claim 2, claim 3 or claim 4 causes said tone arm servo motor to pivot said pivoting tone arm assembly comprising said head shell, said stylus and said sensor into a position determined by said sensor above said phonographic record which corresponds to a selected operating function and wherein said tone arm assembly comprising said stylus may be lowered from said position using said cue lever servo motor to bring said stylus into contact with said phonographic record surface, wherein said tone arm assembly comprising said stylus may be raised from said position using said cue lever servo motor to remove said stylus from contact with said phonographic record in response to an operating function.

9. The phonographic record playing device of claim 1, wherein phonographic record album metadata may be determined using said tone arm servo motor to pivot said pivoting tone arm assembly using said sensor to scan said phonographic record surface wherein said phonographic record surface characteristics may be evaluated by said microcomputer/controller comprising a software application capable of correlating said phonographic record surface characteristics to other phonographic record surface characteristics containing associated metadata.

10. The phonographic record playing device of claim 1, wherein said microcomputer/controller further comprises a software application capable of assigning metadata to phonographic record album tracks.

11. The phonographic record playing device of claim 1, wherein the operating functions of claim 2, claim 3 claim 4 or claim 5 may be controlled by one or more mobile smart phones or other mobile computing devices.

12. The phonographic record playing device of claim 1, wherein the operating functions of claim 2, claim 3 claim 4 or claim 5 may be controlled by a voice command system.

13. The phonographic record playing device of claim 1, wherein said data input/output bank allows for the transfer of data to external storage and/or to other computing devices.

14. The phonographic record playing device of claim 1, wherein said audio input/output bank allows for the connection and transfer of audio data from multiple audio input sources to a single device of claim 1 wherein such audio data sources may be archived concurrently.

15. The phonographic record playing device of claim 1, wherein said wireless capability allows for the wireless connection, communication and transfer of audio data from multiple devices to a single device of claim 1 wherein such audio data sources may be archived concurrently.

16. The phonographic record playing device of claim 1, wherein said wireless functionality allows for the device of claim 1 to communicate audio to wireless headphones and/or other wireless speaker systems.

17. The phonographic record playing device of claim 1, wherein said audio output bank functionality allows for the connection of the device of claim 1 to connect to and transfer audio to amplified or non-amplified audio sources, systems or mixing consoles.

18. The phonographic record playing device of claim 1, wherein said cue lever touch sensor and said head shell stem touch sensor may disengage said cue lever servo motor and/or said tone arm servo motor upon the detection of physical human contact.

19. The phonographic record playing device of claim 1, wherein a lower base plinth and an upper plinth are isolated by natural and/or synthetic materials and assemblies.

20. The phonographic record playing device of claim 1, wherein the components affixed to and/or contained within the said upper plinth may instead be affixed to and/or contained within a single base plinth.
